(19) United States
(12) Patent Application Publication
(10) Pub. No.: US 2006/0077993 A1
(43) Pub. Date: Apr. 13, 2006

(54) Method of managing communication buffers for a plurality of communication layers and node employing the same

(75) Inventors: Luis R. Pereira, Milwaukee, WI (US); Marco Naeve, Milwaukee, WI (US); Sujit R. Das, New Berlin, WI (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 10/963,140

(22) Filed: Oct. 12, 2004

(51) Int. Cl. H04L 12/56

(52) U.S. Cl. 370/412; 370/466

(57) ABSTRACT

A method manages a plurality of communication buffers. The method employs a plurality of communication layers, such as an application layer, a network layer and a MAC layer. A buffer manager is employed for the communication buffers. The buffer manager is independent of the communication layers. The method requests by one of the communication layers one of the communication buffers from the buffer manager. Responsive to the requesting, the method receives at the one of the communication layers an identification of the one of the communication buffers from the buffer manager. One of the communication buffers is employed at the one of the communication layers. The method releases by one of the communication layers the one of the communication buffers to the buffer manager or indicates by one of the communication layers the one of the communication buffers to another one of the communication layers.

### CROSS-REFERENCE TO RELATED APPLICATION

This application is related to commonly assigned, concurrently filed:

U.S. patent application Ser. No.______, filed______, entitled “Method Of Managing Communication Buffers Employing A Quantum Framework For A Plurality Of Communication Layers And Node Employing The Same” (Attorney Docket No. 03-mEDP-305).

### BACKGROUND OF THE INVENTION

1. Field of the Invention

This invention pertains generally to methods of communication and, more particularly, to such methods employing a plurality of communication layers and buffers. The invention also relates to a communicating node including a plurality of communication layers and buffers.

2. Background Information

In order to better achieve flexibility to carry many different types of information over a single system, communication systems are designed with a layered architecture. One example of a general layered architecture for networking protocols and distributed applications is the International Standard Organization's Open System Interconnect (ISO/OSI) model.

The ISO/OSI model comprises a communication system having seven layers which form a communication path between a first end user and a second end user. The seven layers may be divided into two sets: (1) a set of upper layers; and (2) a set of lower layers. The upper four layers (e.g., transport, session, presentation and application layers) normally reside in application end users. A communication system may, in some cases, be defined by the lower three layers, individually known as the network layer, the data link layer and the physical layer.

Each layer is responsible for specific, defined operations in the communication process between application end users. In furtherance of these operations, each layer may communicate information with the layers above and below it through defined interfaces (although there is not always a definitive separation between layers). Thus, for example, the transport layer may operate independently of the specific operational details of the network layer, the data link layer and the physical layer below it. The set of lower layers thus operates as a transparent data pipeline to an application end user connected to the system at the transport layer interface.

A flow of data occurs between layers such as may occur during communication between two application end users. Information may be passed between like layers of each end user through a path ultimately connected at the physical layer. The rules that govern how data is passed between like layers at each end user are collectively referred to as a “peer-to-peer protocol.” A variety of different application end users operating with different peer-to-peer protocols may communicate over a communication system so long as each application end user presents the proper upper layer interface to the communication system. Conversely, an application end user may connect with any communication system having a compatible lower layer interface.

Generally, it is common that only a subset of the seven layers are employed within a network or that one or more layers are merged. Each layer employs the services of the layer below it and provides services to the layers above it. Thus, for example, the network layer, which is responsible for establishing and maintaining the flow of messages between connected points in the network, is dependent upon the data link layer to provide, for example, character and message synchronization and error correction. The data link layer is, in turn, dependent upon the physical layer to actually transmit and receive information as electrical or wireless signals on the network.

Communication stacks are often implemented in a layered structure, with each layer providing a certain function. This allows some flexibility in the implementation, enables compliance with existing standards and permits a certain degree of customization. This also enables an application to become independent from the communication mechanism and allows relatively faster implementation thereof.

A key challenge in implementing a communication stack in a relatively low-cost, embedded environment is the limited resources that are available, especially when using off-the-shelf components, since each layer needs sufficient memory to adequately process incoming and outgoing messages. For example, for a communication stack including an application (APP) layer, a network (NWK) layer, a MAC sub-layer (hereinafter referred to as a “MAC layer”) (e.g., which MAC sub-layer may be all or part of a data link layer) and a physical (PHY) layer, each of these four layers will probably need at least two message buffers (i.e., one for transmit and one for receive). Each of these buffers must be able to hold the largest frame size possible. Although certain optimizations are possible, this mechanism would require a significant amount of memory, which is often not available on relatively small, embedded microcontrollers.

For example, when using a relatively small 8-bit microprocessor, the processing power and available memory are limited. A good memory management system must intelligently utilize the available resources, without adding a significant processing burden. Therefore, the primary objective for such a system is to optimize the usage of available memory space, while keeping the buffer management mechanism relatively simple.

Typically, in communication systems employing a plurality of communication layers, each communication layer includes a plurality of message buffers. As a result, a message frame must be copied from a buffer of one layer to another buffer of another layer. The disadvantage of this “copy frame” model is that it requires processing power, time and memory to copy frames from one buffer to another.

It is also known to employ a linked list to deal with message buffers and communication layers. The disadvantage of this linked list model is that the buffer management is relatively more complex.

A problem exists when implementing a protocol stack in languages such as, for example, the Java language, which have limited memory allocation, access and arrangement operations available, as such a memory allocation scheme cannot be implemented for a protocol stack. Two different techniques have previously been employed in attempts to implement a protocol stack in languages such as Java. These techniques are Protocol Data Unit (PDU) (or layer frame) Encapsulation and Data Buffer Copying.

In PDU encapsulation, a PDU base class is successively encapsulated within classes derived from the PDU base class. For example, an application passes a data buffer to a layer which forms an initial PDU via the constructor PDU(byte []):PDU. This call causes a PDU object, containing the passed data buffer, to be allocated. The layer then adds its header and trailer data to the object and passes it to a lower layer. A lower layer constructs a PDU via a call to the constructor PDU (PDU):PDU, passing the received PDU object to the constructor. This results in a new PDU object being created, encapsulating the received PDU object, and the layer then adds its header and trailer information to the new PDU object.

When the PDU object is to be written to a physical device, the method getBuffer( ):byte[ ] is called. This method allocates a byte array and, understanding the semantics of the header and trailer of the PDU, creates a byte array representation of the header, calls getBuffer( ) on the encapsulated PDU and copies the data into the allocated byte array and then copies a byte array representation of the trailer into the allocated byte array. This technique suffers from excessive object allocation, utilizing memory resources and incurring overhead, and the runtime expense of having to make recursive copies of buffers.

In the second Data Buffer Copying technique, successive allocation and copying of passed data is performed. Specifically, an application passes data to a layer which forms an initial PDU object via the construction PDU (byte[ ]):PDU. This results in a byte array being allocated of a sufficient size to hold the received data and the encapsulating header and trailer. The header is composed in the buffer, after which the received data is copied to the buffer and the trailer is then composed into the buffer.

Lower layers receiving a PDU buffer from a higher layer construct PDU's via calls to the constructor PDU (byte[ ]):PDU, passing the received buffer. This causes a PDU object to be allocated, encapsulating the passed buffer and the encapsulating header and trailer. When the PDU is to be written to a physical device, a layer simply copies the PDU object's buffer to the device.

When a lower layer receives data, the layer allocates a data buffer of sufficient length to hold the PDU's encapsulated payload, copies the payload into the allocated buffer and passes the allocated buffer to the appropriate upper layer. This technique also suffers from excessive object allocation, utilizing memory resources and incurring overhead, and the runtime expense of having to make recursive copies of buffers.

U.S. Pat. No. 6,480,507 discloses that buffers can be pre-allocated in the Java virtual machine (VM), or the like, thus avoiding the performance and memory cost of excessive object allocations. A mechanism is provided by which these buffers can be passed between layers of the stack with little copying of information being required. Three principal mechanisms are employed: (1) a discovery mechanism; (2) a buffer pre-allocation mechanism; and (3) a buffer passing mechanism.

U.S. Patent Application Publication No. 2004/0073724 discloses data transfers utilizing a network stack interface called a SCSI Interface Descriptor (SID). This facilitates inter-layer data transfer by passing memory address pointers (pointers) via SIDs. Essentially, data is stored in an original buffer, and thereafter pointers to the buffer are passed between network stack layers. Each layer then manipulates the pointers to refine them to point to particular areas within the buffer, and then sends the pointer on to the next network stack layer.

Wireless networks are an emerging new technology, which allows users to access information and services electronically, regardless of their geographic position. Wireless networks may be classified in two types: (1) infra-structured networks; and (2) infra-structureless (or ad-hoc) networks. Every ad-hoc network is infra-structureless, but the opposite is not true. A main characteristic of ad-hoc networks is self-configuration.

One type of on-demand ad-hoc routing protocol is Dynamic Source Routing (DSR). A conventional DSR network enables communications between any devices in such network by discovering communication routes to other devices in the network. See, for example, Johnson et al., “Dynamic Source Routing in Ad Hoc Wireless Networks”, Mobile Computing, 1996. Dynamic Source Routing for mobile communication networks avoids periodic route advertisements because route caches are used to store source routes that a mobile host has learned over time. A combination of point-to-point and broadcast routing using the connection-oriented packet forwarding approach is used. Routes are source-initiated and discovered via a route discovery protocol. With source routing, the sender explicitly lists the route in each packet's header, so that the next-hop nodes are identified as the packet travels towards the destination. Cached route information is used and accurate updates of these route caches are essential, otherwise routing loops can occur. Since the sender has to be notified each time a route is truncated, the route maintenance phase does not support fast route reconstruction. See, also, U.S. Pat. Nos. 6,167,025; 6,034,961; and 5,987,011.

The DSR protocol appends a complete list of addresses from one peer device to another peer device for communications. That is, each device in a DSR network knows the entire path to another device, although this stored path may dynamically change.

There is room for improvement in methods employing a plurality of communication layers and buffers. There is also room for improvement in communicating nodes including a plurality of communication layers and buffers.

### SUMMARY OF THE INVENTION

These needs and others are met by the present invention, which provides a mechanism for managing the transmit and receive buffers for a node, such as, for example, an embedded implementation of a low rate-wireless personal area network (LR-WPAN) node. The method targets the buffering of messages for a layered communication architecture. A buffer management entity (BME) intelligently manages limited memory resources of an embedded communicating node, and enables the components of this node to use the same resource pool. This addresses the resource limitation by sharing the available buffer space among the communication layers and managing this in an intelligent fashion.

In accordance with one aspect of the invention, a method of managing a plurality of communication buffers comprises: employing a plurality of communication layers; employing a buffer manager for the communication buffers, the buffer manager being independent of the communication layers; requesting by one of the communication layers one of the communication buffers from the buffer manager; responsive to the requesting, receiving at the one of the communication layers an identification of the one of the communication buffers from the buffer manager; employing the one of the communication buffers at the one of the communication layers; and releasing by one of the communication layers the one of the communication buffers to the buffer manager or indicating by one of the communication layers the one of the communication buffers to another one of the communication layers.

The method may, responsive to the indicating, request from the another one of the communication layers the one of the communication buffers from the buffer manager; and responsive to the requesting by the another one of the communication layers, return at least one pointer to the one of the communication buffers from the buffer manager to the another one of the communication layers.

The method may employ as one of the communication buffers a transmit buffer; employ as at least some of the communication layers an application layer, a network layer and a MAC layer; and request the transmit buffer by one of the application layer, the network layer and the MAC layer.

The method may employ as one of the communication buffers a receive buffer; employ as one of the communication layers a MAC layer; and request the receive buffer from the MAC layer.

The method may employ as some of the communication buffers a receive buffer and a transmit buffer; employ as at least some of the communication layers an application layer, a network layer and a MAC layer; employ a length for each of the receive buffer and the transmit buffer; and request a change by the buffer manager of the length of the receive buffer or the transmit buffer by one of the application layer, the network layer and the MAC layer.

The method may grant such requesting the transmit buffer by the application layer, the network layer and the MAC layer by the buffer manager on a first-come-first-served basis.

The method may receive a message frame in the receive buffer; responsive to the indicating, request from the another one of the communication layers the one of the communication buffers from the buffer manager; and return a pointer to the one of the communication buffers from the buffer manager to the another one of the communication layers.

The method may read data from the message frame in the receive buffer by the another one of the communication layers; and indicate by the another one of the communication layers the receive buffer to yet another one of the communication layers.

The method may, responsive to the indicating by the another one of the communication layers, request from the yet another one of the communication layers the receive buffer from the buffer manager; and return another pointer to the receive buffer from the buffer manager to the yet another one of the communication layers.

The method may employ as one of the communication buffers a receive buffer; request the receive buffer by one of the communication layers; receive a message frame in the receive buffer; remove data of a particular size from the message frame in the receive buffer by the one of the communication layers responsive to the receiving a message frame; and inform the buffer manager of the particular size by the one of the communication layers.

The method may employ as one of the communication buffers a receive buffer; request the receive buffer by one of the communication layers; receive a message frame in the receive buffer; remove data of a particular size from the message frame in the receive buffer by the one of the communication layers responsive to the receiving a message frame; and request the buffer manager to change the receive buffer to a transmit buffer by the one of the communication layers.

As another aspect of the invention, a node comprises: a processor including a memory, a transceiver and a communication routine, wherein the memory includes a plurality of communication buffers, and wherein the communication routine includes a buffer manager adapted to manage the communication buffers and a plurality of communication layers having a physical layer associated with the transceiver, the buffer manager being independent of the communication layers, one of the communication layers being adapted to request one of the communication buffers from the buffer manager, the buffer manager, responsive to the request, being adapted to provide to the one of the communication layers an identification of the one of the communication buffers, the one of the communication layers being adapted to employ the one of the communication buffers, and being adapted to release the one of the communication buffers to the buffer manager or to indicate the one of the communication buffers to another one of the communication layers.

### BRIEF DESCRIPTION OF THE DRAWINGS

A full understanding of the invention can be gained from the following description of the preferred embodiments when read in conjunction with the accompanying drawings in which:

FIG. 1 is a block diagram of a buffer management entity (BME) in accordance with the present invention.

FIG. 2A is an object model diagram of the BME of FIG. 1.

FIGS. 2B1-2B2 form a block diagram of the state machine of the buffer manager of FIG. 2A.

FIG. 2C is a state diagram of the buffer class of FIG. 2A.

FIG. 3 is a block diagram of a network device including the BME of FIG. 1.

FIGS. 4A-4P are message diagrams for assembling frames and transmitting application data by the BME and communication layers of FIG. 1.

FIGS. 5A-5M are message diagrams for receiving application data and disassembling frames by the BME and communication layers of FIG. 1.

FIGS. 6A-6I are message diagrams for other data requests by the BME and the MAC and network communication layers of FIG. 1.

### DESCRIPTION OF THE PREFERRED EMBODIMENTS

As employed herein, the term “wireless” shall expressly include, but not be limited to, radio frequency, infrared, wireless area networks, IEEE 802.11 (e.g., 802.11a; 802.11b; 802.11g), IEEE 802.15 (e.g., 802.15.1; 802.15.3, 802.15.4), other wireless communication standards, DECT, PWT, pager, PCS, Wi-Fi, Bluetooth™, and cellular.

As employed herein, the term “portable communicating device” shall expressly include, but not be limited to, any portable communicating device having a wireless communication port (e.g., a handheld device; a handheld personal computer (PC); a portable or laptop PC; a Personal Digital Assistant (PDA); a mobile or cellular telephone; a wireless Internet device; a protocol-enabled telephone; a portable wireless device).

As employed herein, the term “network coordinator” (NC) shall expressly include, but not be limited to, any communicating device, which operates as the central controller in an ad-hoc communication network.

As employed herein, the term “network device” (ND) shall expressly include, but not be limited to, any communicating device (e.g., a portable communicating device; a fixed communicating device, such as, for example, switches, motion sensors or temperature sensors as employed in a wirelessly enabled sensor network), which participates in an ad-hoc communication network, and which is not a central controller.

As employed herein, the term “node” includes NDs, NCs and other communicating devices.

For convenience of disclosure, the following acronyms are employed herein:

APP: application layer

NWK: network layer

MAC: medium access sub-layer

PHY: physical layer

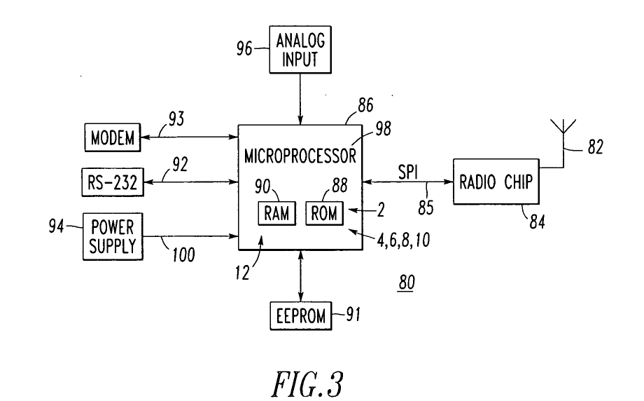

The present invention is described in association with a wireless node 80 (FIG. 3), although the invention is applicable to a wide range of communicating devices.

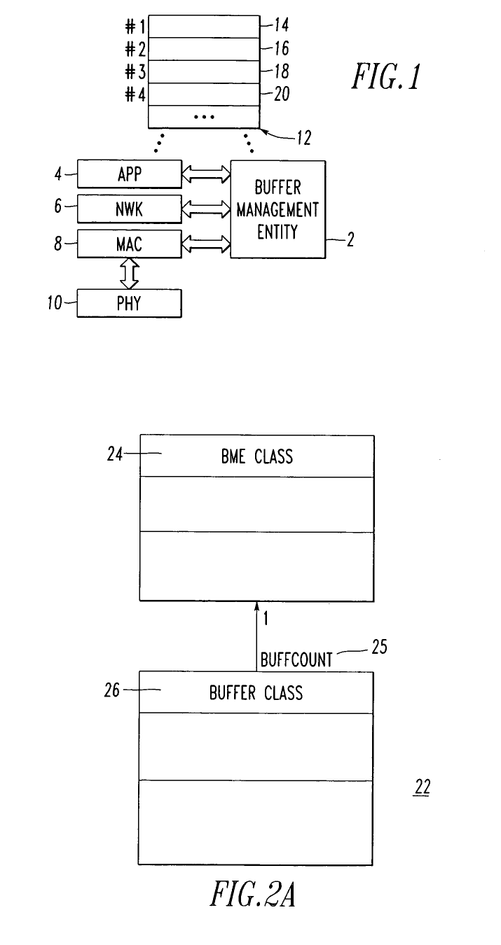

Referring to FIG. 1, high level interaction is shown between a buffer management entity (BME) 2 and a plurality of communication layers, such as the application (APP) layer 4, the network (NWK) layer 6 and the MAC sub-layer 8 (hereinafter referred to as “MAC layer 8”) (e.g., which MAC sub-layer 8 may be all or part of a data link layer (not shown)). There is also a physical (PHY) layer 10 that interfaces with the MAC layer 8. The BME 2 functions as a buffer manager for a plurality of communication buffers 12 and is independent of the communication layers 4,6,8,10. As will be explained, the layers 4,6,8 request one or more of the communication buffers 12 from the BME 2 and release those requested buffers back to the BME after they are “consumed” (e.g., for a TX buffer, the message has been fully transmitted; for an RX buffer, the message has been considered by all layers and is no longer needed by the APP layer 4; a buffer no longer serves a useful purpose).

The BME 2, therefore, provides a mechanism for managing the communication buffers 12 for the communication layers 4,6,8. Briefly, the management mechanism includes: (1) requesting by one of the communication layers 4,6,8 one of the communication buffers 12 from the BME 2; (2) responsive to this requesting, receiving at the requesting one of the communication layers 4,6,8 an identification of the requested one of the communication buffers 12 from the BME 2; (3) employing (e.g., for transmitting or receiving a message frame) the requested one of the communication buffers 12 at one of the communication layers 4,6,8,10; and (4) releasing by one of the communication layers 4,6,8 the requested one of the communication buffers 12 to the BME or indicating by one of the communication layers 4,6,8 the requested one of the communication buffers 12 to another one of the communication layers 4,6,8,10.

The BME 2 employs at least enough memory for the communication buffers 12 to store two message frames (e.g., one transmit buffer 14 and one receive buffer 16) of the largest possible size as defined by the communication protocol that employs the BME management mechanism. However, in order to accommodate incoming and outgoing messages without losing any of them, the BME 2 preferably has at least four buffers 14,16,18,20. Each of the buffers 14,16,18,20 can become a transmit buffer or a receive buffer depending on the needs imposed by the message traffic, although certain rules may apply. If, for example, the BME 2 has four buffers, then there is preferably one transmit buffer, one receive buffer, one dedicated MAC buffer, and a “spare” buffer.

Each of the layers, such as 4,6,8 (e.g., typically the MAC layer 8 and higher), which can send messages to a neighboring communicating device (not shown), can request one of the communication buffers 12 for creating a message frame.

### EXAMPLE 1

The BME 2 can grant these requests either on a first-come-first-served basis or based upon certain rules depending on the incoming and outgoing traffic flow. The employed rules may favor a direction (i.e., incoming; outgoing) or may try to balance the number of transmit and receive buffers. After an outgoing message is sent successfully, the buffer is released again and a different one of the layers 4,6,8 may request its use. Incoming messages are stored in a receive buffer. When a new message is received, a new buffer is made available immediately for the next incoming message. After the newly received message is consumed by its intended layer, the buffer is released and is made available for the other layers to use.

### EXAMPLE 2

The application layer 4 may request a transmit buffer for sending application data. The network layer 6 may request a transit buffer for sending a network layer command frame. The MAC layer 8 may request a transmit buffer for sending a MAC command frame. The physical layer 10 does not directly interact with the BME 2, since that layer does not need to send any command messages on its own and since it does not know when a buffer for a transmitted message can be released because the MAC layer 8 is responsible for reliable message transmission. Instead, the physical layer 10 reads and writes to the buffers 12 as assigned by the MAC layer 8.

### EXAMPLE 3

Although FIG. 1 shows a direct interface between the BME 2 and the layers 4,6,8, internal messages (or events) may be passed among the various layers 4,6,8,10 using a suitable event manager entity (or framework) (not shown). If, for example, the MAC layer 8 needs one of the buffers 12, then it generates a BME buffer request event, which is then passed to the BME 2 by the event manager entity.

### EXAMPLE 4

Alternatively, the BME 2 may be implemented as a function call (not shown).

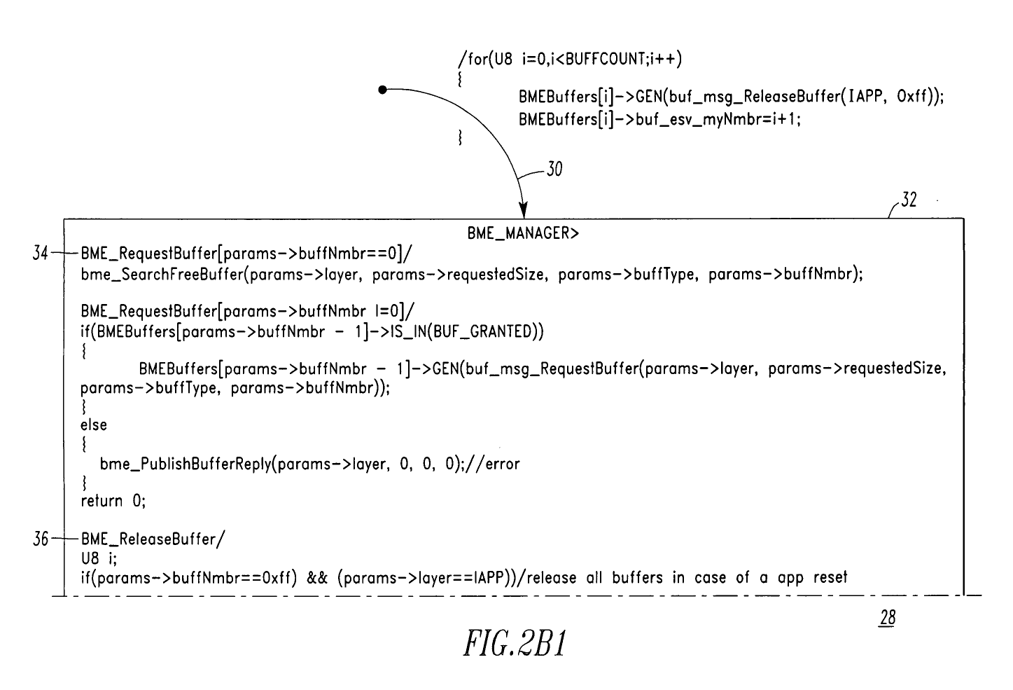

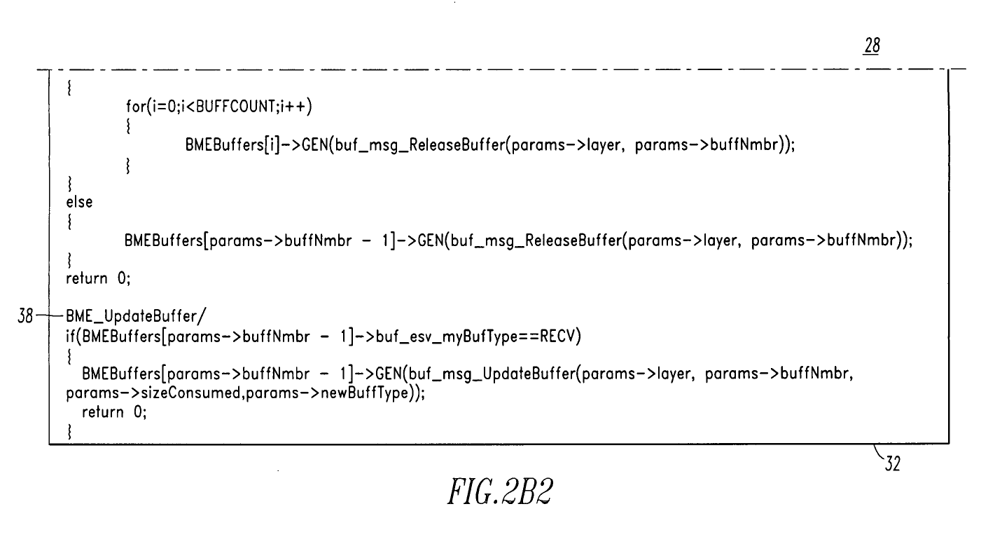

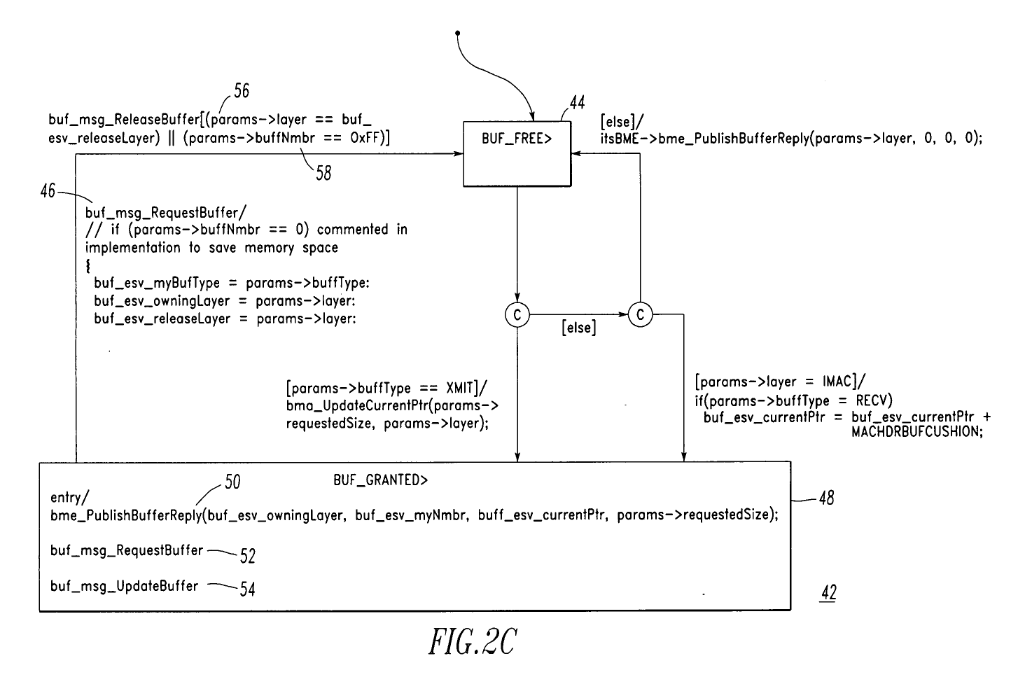

Referring to FIG. 2A, an object model diagram 22 of the buffer management entity 2 of FIG. 1 is shown. This diagram 22 consists of one instance of a buffer manager class (BME CLASS) 24 and multiple (BUFFCOUNT 25) instances of a buffer class (BUFFER CLASS) 26. The buffer manager class 24 controls the assignment of the individual buffers 12 of FIG. 1, while the memory usage is independently controlled by each of those buffers 12. Each of the buffers 12 has sufficient memory to store the largest possible message size handled by the layers 4,6,8,10, which form the associated communication stack of FIG. 1.

The buffer manager class 24 receives buffer requests from the discrete layers 4,6,8 of the communication stack of FIG. 1, searches a list (not shown) of available ones of the buffers 12 for availability, and confirms the acceptance of the buffer request back to the requesting one of the layers 4,6,8. The confirmation indicates the assigned buffer number (e.g., without limitation, #1, #2, #3, #4 of FIG. 1).

The buffer manager class 24 consists of a single state only. All buffer request, buffer release, and confirmation events are handled by actions internal to this state. The state machine 28 of the buffer manager class 24 is shown in FIGS. 2B1-2B2. Upon instantiation of the buffer manager state machine 28, the action in the default transition 30 is executed, which resets all buffers 12 of FIG. 1 to their default (e.g., “free”) state, thereby ensuring that all buffers 12 are in a known condition. After the action in the default transition 30 is executed, the BME_Manager state 32 is entered, which state waits for events from the layers 4,6,8 (FIG. 1) of the communication stack. There are three types of events that are handled by the state 32: (1) the BME_RequestBuffer 34; (2) the BME_ReleaseBuffer 36; and (3) the BME_UpdateBuffer 38 events. The state 32 replies to events from any of the layers 4,6,8 (FIG. 1) with a BME_Buffer_Reply event (Table 4), which is directed to the one of the layers 4,6,8 (FIG. 1) that initiated the request.

Referring to FIGS. 1 and 2B1-2B2, the BME_RequestBuffer 34 event has four parameters, which are shown in Table 1. This event is employed for two purposes. One of the layers 4,6,8 may use this event to request a new one of the buffers 12 or to request the current buffer pointer of a buffer that has already been assigned. This action also transfers the right to access an assigned buffer from one of the layers 4,6,8 of the communication stack to the next layer thereof. When the BME_RequestBuffer parameter is issued with the buffNmbr parameter equal to zero, this means that the requesting layer (indicated by the Layer parameter) is requesting a new buffer for storing a new, to be created, message frame. When the buffNmbr parameter is not equal to zero, this means that a buffer has already been assigned and the layer is requesting access to the buffer.

TABLE 1

| Parameter | Range | Description |
|---|---|---|
| Layer | MAC, NWK or APP | Indicates which layer of the |
| | | communication stack issued the |
| | | request. |
| RequestedSize | 1 to maxPacketSize | The number of bytes that the |
| | | layer requests. |
| BufferType | TX, RX or Other | Indicates if the buffer contains a |
| | | frame to be transmitted, a frame |
| | | that was received or is used for |
| | | other purposes |
| buffNmbr | 0 to BUFFCOUNT | Indicates which buffer this |
| | | request is intended for; 0 means |
| | | a new buffer is requested. |

The BME_ReleaseBuffer 36 event has two parameters, which are shown in Table 2. This event frees a currently assigned buffer, making it available for other layers to use. Unlike the BME_RequestBuffer 34 and BMEUpdateBuffer 38 events, the BME_ReleaseBuffer 36 request is not confirmed using the BME_Buffer_Reply event (Table 4).

TABLE 2

| Parameter | Range | Description |
|---|---|---|
| Layer | MAC, NWK or APP | Indicates which layer of the |
| | | communication stack issued the |
| | | request. |
| buffNmbr | 1 to BUFFCOUNT | Indicates which buffer this |
| | | request is intended for. |

The BME_UpdateBuffer 38 event has four parameters, which are shown in Table 3. This event applies only to buffers 12 that are receive buffers (i.e., type RX) and is used to indicate how many bytes (e.g., header information) were removed from the message frame in the buffer memory by one of the layer 4,6,8. Alternatively, this event can be used by one of the layers 4,6,8 to change the direction (usage) (e.g., from type RX to type TX; from type TX to type RX) of a buffer.

### EXAMPLE 5

The network layer 6 is allowed to change the usage (direction) of a receive (RX type) buffer to a transmit (TX type) buffer. This feature is employed by the network layer 6 to route messages from one node (e.g., 80 of FIG. 3) to another node (not shown) without needing to copy the received message frame from a receive buffer to a transmit buffer. In this example, the BME 2 limits changes in usage (direction) to only this feature.

TABLE 3

| Parameter | Range | Description |
|---|---|---|
| Layer | MAC, NWK or APP | Indicates which layer of the |
| | | communication stack issued |
| | | the request. |
| buffNmbr | 1 to BUFFCOUNT | Indicates which buffer this |
| | | request is intended for. |
| SizeConsumed | 0 to maxPacketSize | The number of bytes that a |
| | | layer removed from a frame |
| | | (layer specific header |
| | | information). |
| NewBuffType | TX or RX | Indicates if a buffer changes |
| | | its direction (currently only |
| | | RX to TX is allowed). |

The BME_Buffer_Reply event has three parameters, which are shown in Table 4. This event confirms BME_RequestBuffer 34 and BME_UpdateBuffer 38 events coming from various layers 4,6,8 of the communication stack. The buffNmbr parameter indicates which buffer has been assigned. A buffNmbr parameter of 0 indicates an error and that no buffer has been assigned. The buffLocation parameter contains the pointer to the memory location of the assigned buffer considering the one of the layers 4,6,8 that issued the request and the size of the headers that will be placed in front of the message payload.

TABLE 4

| Parameter | Range | Description |
|---|---|---|
| buffNmbr | 0 to BUFFCOUNT | Indicates the number of the |
| | | buffer, which has been |
| | | assigned. |
| buffLocation | Pointer | The pointer to the location in |
| | | the memory of the buffer |
| | | where the requesting layer can |
| | | start writing its payload. |
| SizeAllocated | 0 to macFrameSize | Confirms the number of bytes |
| | | that the layer requested. |

The BME 2 (FIG. 1) has multiple instances of the buffer class 26 (FIG. 2A). The number of buffers (BUFFCOUNT 25) that an instantiation of the BME 2 may contain is implementation specific and depends on the amount of available memory and the traffic the layers 4,6,8,10 of a particular communication stack may need to handle. Each of the buffers 12 has two states indicating its usage: (1) free/available; or (2) granted/assigned. The state diagram 42 of the buffer class 26 is shown in FIG. 2C. Each instance of the buffer class 26 only receives events that have been forwarded by the buffer manager class 24 (FIG. 2A); in turn each one of the buffers 12 will only send events to the buffer manager class 24. The events that each instance of the buffer class 26 issues and receives are identical to the events of the buffer manager class 24 since that class simply forwards them.

Referring to FIGS. 1 and 2C, when one of the buffers 12 is in the BUF_FREE state 44, it only accepts the buf_msg_RequestBuffer 46 (the BME internal translation of BME_RequestBuffer 34) event, all other events will be ignored. On receipt of a buf_msg_RequestBuffer 46 event, the state machine 42 transitions from the BUF_FREE state 44 and saves the buffer type parameter and the requesting layer parameter to local variables. Any one of the layers 4,6,8 of the communication stack may request a transmit buffer. If a transmit buffer is requested, then the pointer to the location of the memory is calculated based on which layer requested the buffer and the predefined maximum header overhead for each layer of the communication stack. This is important since each layer will put its header in front of the payload received from the higher layers. After the calculation has been executed, the buffer's state machine 42 transitions into the BUF_GRANTED state 48.

### EXAMPLE 6

Only the MAC layer 8 may request one of the buffers 12 of type OTHER or type RX (receive). If the other layers 4,6 make a request for a type OTHER or type RX buffer, then the request will be denied and the state machine 42 will go back to the BUF_FREE state 44. When the MAC layer 8 requests a type RX buffer, the pointer to the memory location is calculated; otherwise, the pointer is assumed to be the beginning of the local buffer's memory. For example, this is done to accommodate potentially larger size headers in case the received message has to be rerouted to another node. On completion, the state machine 42 will transition into the BUF_GRANTED state 48.

On entry into the BUF_GRANTED state 48, the state machine 42 issues the confirmation event called bme_PublishBufferReply 50, which is translated into the BME_Buffer_Reply event (Table 4) by the buffer manager class 24 (FIG. 2A). When in the BUF_GRANTED state 48, the state machine 42 accepts the buf_msg_RequestBuffer 52, buf_msg_UpdateBuffer 54, and the buf_msg_ReleaseBuffer 56 events. This was discussed, above, in connection with the BME_RequestBuffer 34 and BME_UpdateBuffer 38 events for the state machine 28 (FIGS. 2B1-2B2).

When the buffer is in the BUF_GRANTED state 48 and receives a buf_msg_ReleaseBuffer 56 event, the state machine 42 checks if the communication layer issuing the request currently owns the buffer; otherwise, the request will be ignored. This may be overwritten by setting the buffNmbr parameter 58 to 0×FFH, which is typically used by the application layer 4 to free all buffers 12 after the communication stack has been reset. After the buffer has been released, the buffer's state machine 42 will return to the BUF_FREE state 44 and all local variables will be reset to their default values.

### EXAMPLE 7

Table 5, below, shows the responsibility of the communication layers 4,6,8,10 with respect to the buffer management functions.

TABLE 5

| Tasks | PHY 10 | MAC 8 | NWK 6 | APP 4 |
|---|---|---|---|---|
| TX Buffer Request | No | Yes | Yes | Yes |
| RX Buffer Request | No | Yes | No | No |
| TX Buffer Release | No | Yes | Yes | Yes |
| RX Buffer Release | No | Yes | Yes | Yes |
| TX Length Update | No | Yes | Yes | Yes |
| RX Length Update | No | Yes | Yes | Yes |
| Other Buffer Request | No | Yes | No | No |
| Other Buffer Release | No | No | Yes | No |

MAC layer 8 TX and RX Buffer Release are employed for MAC command, discovery (e.g., beacon) and acknowledgement frames. The network layer 6 TX and RX Buffer Release are employed for NWK command frames. The application layer 4 TX and RX Buffer Release are employed for data frames. Other Buffer Request and Other Buffer Release header and footer rules do not apply to “Other” buffers.

Table 6 shows various BME Primitives.

TABLE 6

| Primitive Name | Event Parameters | Parameter Descriptions |
|---|---|---|
| BME_ReleaseBuffer | LR_Layers layer | Stack layer which is |
| | | releasing the buffer |
| | U8 buffNmbr | The number of the buffer |
| | | which is being released |
| BME_RequestBuffer | LR_Layers layer | Stack layer which is |
| | | requesting the buffer |
| | U8 requestedSize | The requested size of the |
| | | requested buffer |
| | BufferType | The type of buffer being |
| | buffType | requested |
| | U8 buffNmbr | The number of the buffer |
| | | being requested (0 for |
| | | new) |
| BME_UpdateBuffer | LR_Layers layer | Stack layer which is |
| | | updating the buffer data |
| | U8 buffNmbr | The number of the buffer |
| | | being updated |
| | U8 sizeConsumed | The size consumed by the |
| | | buffer (previous to |
| | | update); this is used to |
| | | update the buffer pointer |
| | | in the BME |
| | BufferType | The type to which the |
| | newBuffType | buffer is being changed |

wherein:

BME_ReleaseBuffer 36 is a request by one of the communication layers 4,6,8 for the BME 2 to release a specific one of the buffers 12 from usage, thereby allowing the BME 2 to free the buffer memory.

BME_RequestBuffer 34 is a request by one of the communication layers 4,6,8 for the BME 2 to request one of the buffers 12, where buffNmbr is 0 for a new request, and, otherwise, buffNmbr is the buffer pointer requested. The layer requesting the buffer is set to the owner.

BME_UpdateBuffer 38 is an update for the type of the specific one of the buffers 12 for a specific buffer number or when the pointer for a particular buffer needs to be updated (e.g., due to the layers 4,6,8 removing headers on a reception).

LR_Layers is an enumerated type that indicates the specific one of the layers 4,6,8 requesting the services (e.g., without limitation, APP=1; NWK=2; MAC=3; PHY=4; any suitable identifier to distinguish between communication layers).

U8 is an unsigned byte, which ranges from 0 to 255.

BufferType is an enumerated type that indicates the current usage of the buffers 12 (e.g., TX; RX; Other). The newBuffType tells the BME 2 how this buffer is going to be used, in order that the pointer operations can be done correctly.

There are three valid instructions the layers 4,6,8 can tell the BME 2: (1) to release; (2) to request; and (3) to update (take ownership of) one of the buffers 12. Since these primitives are accessible to all the layers 4,6,8, each one of those layers needs to identify itself, in order that the BME 2 can do the appropriate pointer operations for the requesting layer. That information is provided in the “layer” event parameter.

The particular one of the buffers 12 to be accessed is passed in the buffNmbr parameter. With this implementation, up to, for example, 254 buffers can be used. A buffNmbr parameter of zero means that the particular one of the layers 4,6,8 needs a new buffer.

The parameter sizeConsumed tells the BME 2 how many bytes were used by the particular one of the layers 4,6,8, in order that the BME 2 can rearrange the internal pointers in case the next layer requests it the next time.

The BME 2 manages the message frame buffers 12 that are used by all communication layers 4,6,8,10, which use, produce or consume message frames. The BME 2 preferably: (1) provides buffers 12 that are shared among all layers 4,6,8,10; (2) manages buffer requests on a first-come first-served basis; (3) provides a count of buffers 12 for N messages (e.g., N is a suitable message count of four; greater than four; 15; any suitable count of buffers based upon available memory); (4) each of the buffers 12 can hold M bytes (e.g., M is a suitable buffer size, which is protocol specific and dependant upon the lowest layer protocol, i.e., the physical layer 10); and (5) provides the buffers 12 that can be implemented with one of various different data structures, such as a simple array, a linear queue or a circular queue. Each of the buffers 12 employs sufficient memory to store the largest possible data frame, although some or most of the message frames may be significantly smaller.

The BME 2 preferably employs the following rules while managing its buffers 12: (1) when granting a request for a transmit buffer, the BME 2 ensures that at least one of the buffers 12 for receiving the corresponding acknowledgement is available; (2) when granting a request for a receive buffer, the BME 2 ensures that at least one of the buffers 12 for a future transmit request is available; (3) for the “Other Buffers” and “Transmit Buffers”, the BME 2 is aware of the type of message that is being sent, in order to return the correct pointer in the corresponding one of the buffers 12, thereby allowing sufficient space for the lower layer headers in front of the payload.

Table 7, below, shows messages for data transmission between the layers 4,6,8,10. These messages have no direct relation with the BME 2. In the BME 2, the layers 4,6,8,10 exchange a buffer number (a token), in order that the next layer can retrieve the particular one of the buffers 12. All these primitives are of type DATA. What the particular one of the layers 4,6,8,10 tells its peer layer is just the buffer number (handle) to be transferred and the number of bytes used in that particular one of the buffers 12. Then, the next layer requests ownership of that buffer and processes it.

TABLE 7

| Primitive | Destination |
|---|---|
| NK_DATA.request | NWK layer 6 |
| NK_DATA.confirm | APP layer 4 |
| NK_DATA.indication | APP layer 4 |
| MCPS_DATA.request | MAC layer 8 |
| MCPS_DATA.confirm | NWK layer 6 |
| MCPS_DATA.indication | NWK layer 6 |
| PD_DATA.request | PHY layer 10 |
| PD_DATA.confirm | MAC layer 8 |
| PD_DATA.indication | MAC layer 8 |
| PD_DATA.indication | PHY layer 10 |

### EXAMPLE 8

FIG. 3 is a block diagram of a node 80 including an antenna port 82, a radio frequency (RF) front-end transceiver 84, a serial peripheral interface (SPI) 85, a micro-controller core 86 having ROM 88 and RAM 90, an external EEPROM 91, a programming port 92 (e.g., RS-232), a modem port 93, a power supply 94 and a suitable sensor interface, such as an analog input 96. An 8-bit microprocessor 98 of the core 86 executes code for each of the layers 4,6,8,10 of FIG. 1. In this example, the buffers 12 are internal to the microprocessor 98, although they may be part of any suitable processor's internal or external memory. The buffers 12 are preferably part of a single array. Alternatively, a linear queue, a circular queue or other suitable storage mechanism may be employed.

The sensor interface may include, for example, more or more analog-to-digital inputs, one or more digital-to-analog outputs, one or more UART ports, one or more SPIs and/or one or more digital I/O lines (not shown).

The voltage 100 of the power supply 94 may be, for example, about 3.0 to about 3.3 VDC, although any suitable voltage may be employed (e.g., 5 VDC, 1 VDC).

The micro-controller core 86 may have, for example, ROM code space of about 32 Kbytes and RAM space of about 2 Kbytes.

### EXAMPLE 9

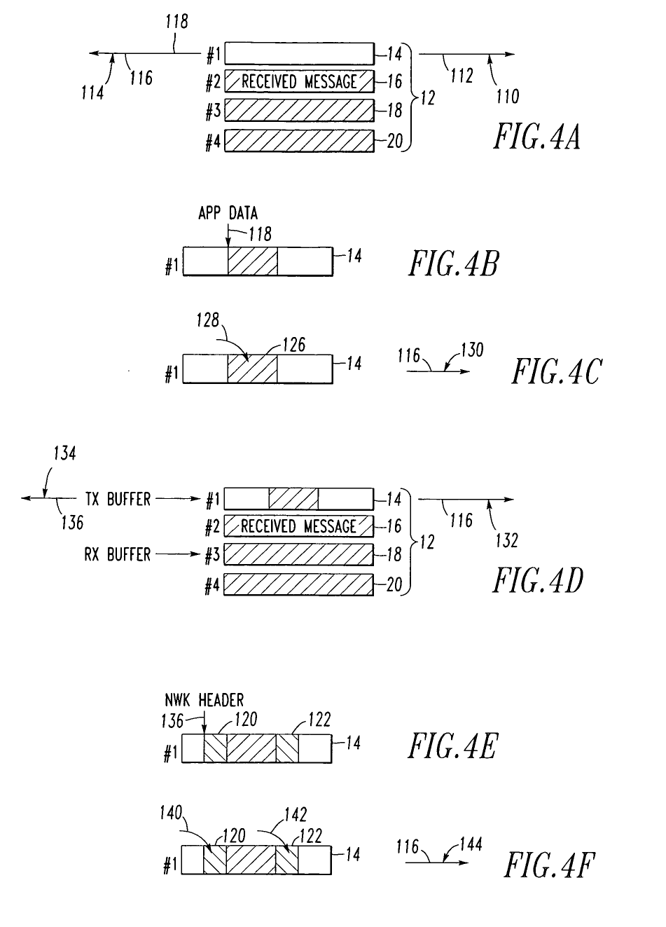

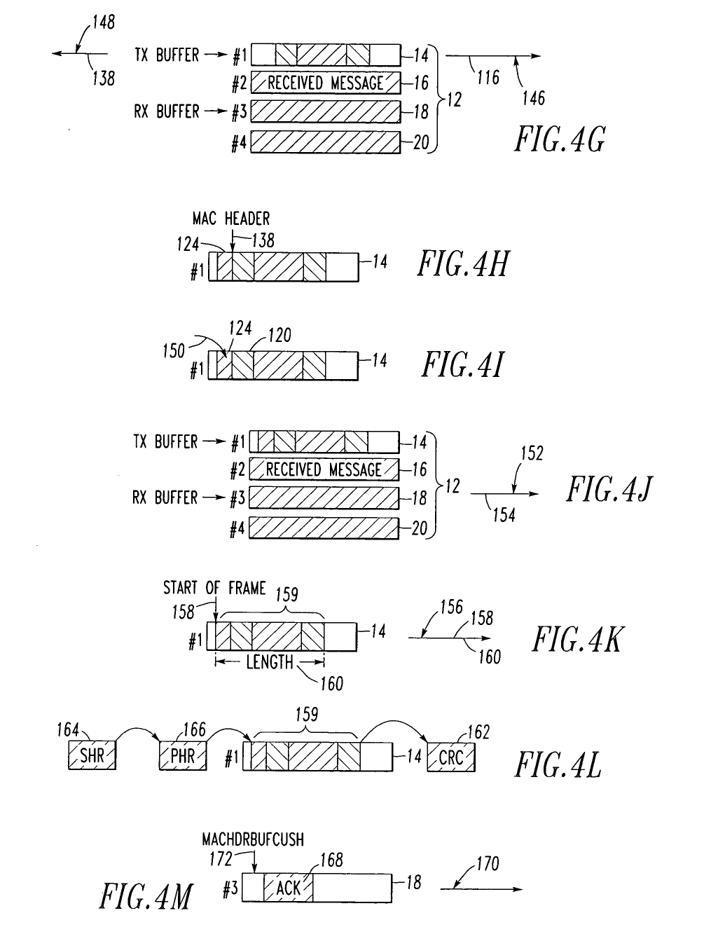

Referring to FIGS. 1 and 4A-4P, an example of how the BME 2 transmits application data including the interaction of the layers 4,6,8 with the BME 2, in order to assemble a message frame, such as 159, is shown.

First (FIG. 4A), the application layer 4 requests a new transmit buffer (e.g., buffer 14) from the BME 2 by sending a BME_RequestBuffer (Buffer Request) message 110 to the BME 2 and specifying the number of bytes 112 it wants to send. Here, also, the receive buffer 16 was reserved and the other buffers 18,20 are free/available. Next, the BME 2 checks if a buffer (e.g., buffer 14) is available and may, also, check to see if there is at least one receive buffer (e.g., buffer 16) available. The BME 2 grants the request and, then, returns (BME_Buffer_Reply event (Table 4), at 114, the buffer number 116 (e.g., #1) and a pointer 118 (as best shown in FIG. 4B) to the part of the buffer 14 where the application layer 4 can write its data. The BME 2 also ensures that sufficient space is available for the NWK header 120 (FIG. 4E), NWK footer 122 (FIG. 4E) and MAC header 124 (FIG. 4H). Finally, the BME 2 sets the application layer 4 as both the owner and releaser (as the release layer) of the buffer 14.

Then (FIG. 4C), the application layer 4 fills the assigned buffer space 126 with its data 128 and issues a NK_DATA.request primitive 130 to the network layer 6 indicating the buffer number 116 (FIG. 4A) and handing off the control of the buffer 14 to the network layer.

The network layer 6 requests (FIG. 4D) to add its header 120 (FIG. 4E) and footer 122 (FIG. 4E) to the message in the buffer 14 by sending a Buffer Request message 132 to the BME 2. The size of the NWK header 120 is not specified because it is fixed. The request message 132 contains the buffer number 116 received from the NK_DATA.request primitive 130 (FIG. 4C). Then, the BME 2 returns, at return event 134, a pointer 136 (as best shown in FIG. 4E) to the location where the network layer 6 can add its header 120 (and after a suitable length calculation by the network layer 6, its footer 122). The BME 2 also sets the network layer 6 as the current owner of the buffer 14. Since the size of the header 120 is either fixed or transmitted in the Buffer Request message 132 (FIG. 4D), the BME 2 returns the correct pointer location.

For data transmission, the BME 2 returns the pointer 136 to the network layer 6 and a pointer 138 (FIG. 4H) to the MAC layer 8, because the network layer 6 does not know or care where the application data 128 (FIG. 4C) went and, instead, only cares where its NWK header 120 will go (after giving the size to the BME 2).

Next (FIG. 4F), the network layer 6 fills the assigned buffer space 120 and 122 with its header information 140 and footer information 142, respectively, thereby ensuring that the application data 128 (i.e., APP payload) (FIG. 4C) is not destroyed. The network layer 6 ensures that the APP payload is not destroyed by not writing more than the length of its header 120. After the NWK header 120 and NWK footer 122 are written to the buffer 14, the network layer 6 issues a MCPS_DATA.request primitive 144 to the MAC layer 8 indicating the buffer number 116 and handing off the control of the buffer 14 to the MAC layer 8.

Then (FIG. 4G), the MAC layer 8 requests to add its header 124 (FIG. 4H) to the message in the buffer 14 by sending a Buffer Request message 146 to the BME 2. The request message 146 contains the buffer number 116 received from the MCPS_DATA.request primitive 144 (FIG. 4F). The BME 2 returns, at return event 148, the pointer 138 to the location where the MAC layer 8 can add its header 124 (FIG. 4H). Here, as shown in FIG. 4H, the pointer 138 is an “end pointer” to the header 124 because the MAC layer 8 writes the header 124 in reverse order or backwards. The BME 2 also sets the MAC layer 8 as the owner of the buffer 14.

Next (FIG. 4I), the MAC layer 8 fills the assigned buffer space 124 with its header information 150 ensuring that the network header 120 is not destroyed.

Then (FIG. 4J), the MAC layer 8 retrieves a receive buffer, such as buffer 18, from the BME 2 by sending a Buffer Request 152 with Buffer Number 154 of 0, in order to request a new buffer, from the BME 2.

Then (FIG. 4K), the MAC layer 8 sends a PD_DATA.request primitive 156 to the physical layer 10 with a pointer 158 to the beginning of the frame 159 to be transmitted and its length 160, which hands off the control of the buffer 14 to the physical layer 10.

Next (FIG. 4L), the physical layer 10 generates the CRC 162 of the frame 159. The physical layer 10 also transmits the synchronization header (SHR) 164, the PHY header (PHR) 166, the frame 159 and the CRC 162.

Then (FIG. 4M), the physical layer 10 receives an incoming packet 168 and writes it into the current receive buffer 18. The synchronization and PHY headers 164,166 are not saved in the buffer 18. After checking the CRC 162, the physical layer 10 sends a PD_DATA.indication primitive 170 to the MAC layer 8.

### EXAMPLE 10

FIG. 4M shows a MACHDRBUFCUSH (MAC Header buffer cushion) 172. The BME 2 may be employed for a PSR algorithm implementation (e.g., as disclosed in U.S. patent application Ser. No. 10/441,315). Each node, such as 80 of FIG. 3, can receive packets from other nodes (not shown) and, then, retransmit them by adding its own address (e.g., increment/decrement routing). With the BME 2, there is no need to rebuild the packet, in order to retransmit it, thereby saving time and effort. However, sometimes, it is needed to send some information at the “left” side (e.g., with respect to FIG. 4M) of the packet to be re-transmitted. Hence, the “cushion” 172 is reserved at the MAC level, in order that there is sufficient room for those extra bytes for re-transmission.

Next, the MAC layer 8 receives the PD_DATA.indication primitive 170 (FIG. 4M) from the physical layer 10. Then, the MAC layer 8 evaluates the received message 168 and determines that it is the acknowledgement (ACK) of the previous transmission. Since the transmission was successful, the MAC layer 8 issues a MCPS_DATA.confirm primitive 172 to the network layer 6 as shown in FIG. 4N.

Next (FIG. 4O), the network layer 6 issues a NK_DATA.confirm primitive 174 to the application layer 4.

Finally, upon receipt of the confirm primitive 174, the application layer 4 assumes the requested data transmission was successful and releases, at BME_ReleaseBuffer event 176, the transmit buffer 14 back to the BME 2 as shown in FIG. 4P. That buffer 14 is now available for the various layers 4,6,8 to use.

### EXAMPLE 11

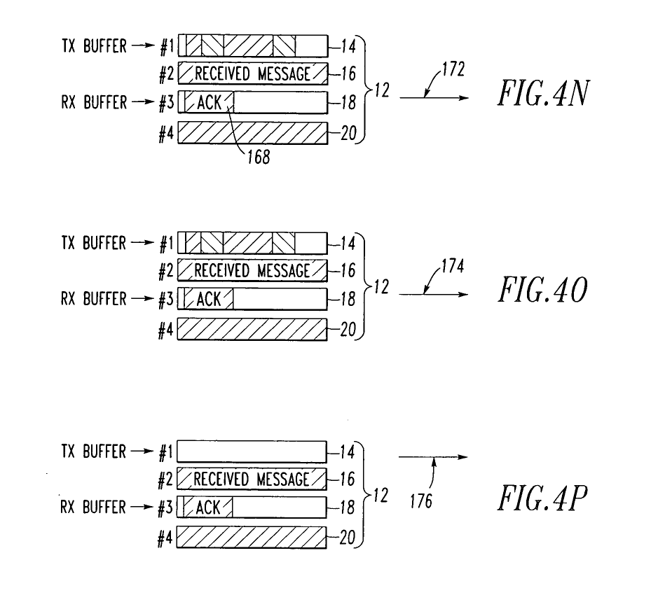

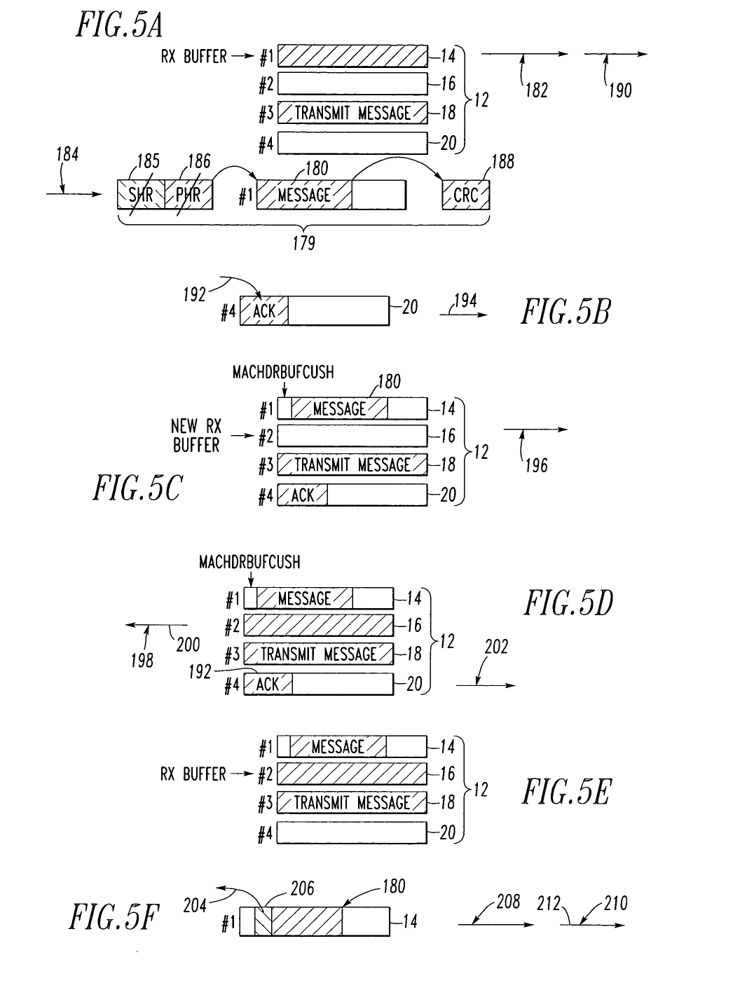

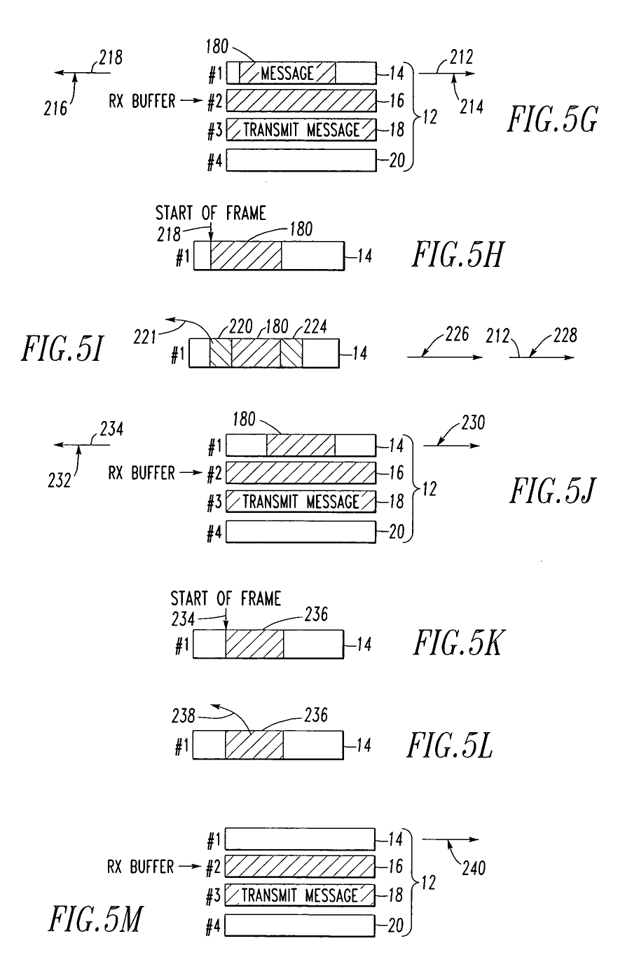

Referring to FIGS. 1 and 5A-5M, an example of data reception when an application data packet 179 (FIG. 5A) is received is shown. The following describes the interaction of the layers 4,6,8 with the BME 2, in order to extract the received message 180. Before a data packet can be received, the MAC layer 8 requests with Buffer Request message 182 a receive buffer (e.g., buffer 14) from the BME 2 and initializes the physical layer 10. When the MAC layer 8 is initialized, it sends an initialization message 184 to the physical layer 10. Then, the physical layer 10 receives the incoming data packet 179 and writes it into the current receive buffer 14. The synchronization header (SHR) 185 and PHY header (PHR) 186 are not saved in the buffer 14. After the CRC 188 has been checked, the physical layer 10 issues a PD_DATA.indication primitive 190 to the MAC layer 8 indicating the buffer 14.

Next, the MAC layer 8 analyzes the received message 180 in the buffer 14, creates an acknowledgement frame 192 (FIG. 5B), and issues a PD_DATA.request primitive 194 to the physical layer 10 causing the frame 192 to be sent to the sender (not shown) of the data packet 179.

Then, the MAC layer 8 requests with Buffer Request message 196 (FIG. 5C) a new receive buffer (e.g., buffer 16) from the BME 2, in order that this buffer is ready to receive a new data packet, since the last buffer 14 is occupied with fresh data of the message 180.

Then (FIG. 5D), the BME 2 checks if one of the buffers 12 is available and may, also, check to confirm if there is at least one transmit buffer (e.g., buffer 18) available. When the BME 2 grants, at return event 198, the Buffer Request message 196, it returns the buffer number 200 (e.g., #2) and sets the MAC layer 8 as the owner and origin of that buffer.

Next (FIG. 5E), the MAC layer 8 requests the new receive buffer 16 upon receipt of the PD_DATA.confirm primitive 202 (FIG. 5D) from the physical layer 10 confirming that the ACK packet 192 has been sent.

Then (FIG. 5F), the MAC layer 8 extracts, at 204, the MAC header 206 from the received message 180 and updates the BME 2 on the number of bytes it removed by sending a Buffer Update message 208. Next, the MAC layer 8 issues a MCPS_DATA.indication primitive 210 to the network layer 6, indicating the buffer number 212 (e.g., #1), and handing off control of the buffer 14 to the network layer 6.

As shown in FIG. 5G, upon receipt of the MCPS_DATA.indication primitive 210, the network layer 6 requests the current starting pointer for the received message 180 from the BME 2 by sending a Buffer Request message 214 containing the buffer number 212 from the MCPS_DATA.indication primitive 210. Then, the BME 2 returns, at return event 216, the pointer 218 (as best shown in FIG. 5H) indicating the start of the NWK header 220 (as best shown in FIG. 5I) of the received message 180.

Next (FIG. 5I), the network layer 6 extracts, at 221, the NWK header 220 and NWK footer 224 from the received message 180 and updates the BME 2 on the number of bytes it removed by sending a Buffer Update 226. Then, the network layer 6 issues a NK_DATA.indication primitive 228 to the application layer 4, indicating the buffer number 212.

Then (FIG. 5J), upon receipt of the NK_DATA.indication primitive 228, the application layer 4 requests with BME_RequestBuffer event 230 the current starting pointer for the received message 180 (FIG. 5I) from the BME 2. The BME 2 returns, at return event 232, the pointer 234 (as best shown in FIG. 5K) indicating the start of the APP data 236 of the received message 180 (FIG. 5J).

Next (FIG. 5L), the application layer 4 extracts, at 238, the APP data 236 from the received message 180 (FIG. 5J).

Finally (FIG. 5M), since all data has been extracted, the receive buffer 14 is now released, at BME_ReleaseBuffer event 240, back to the BME 2 and the buffer 14 is available for any of the layers 4,6,8 to use.

### EXAMPLE 12

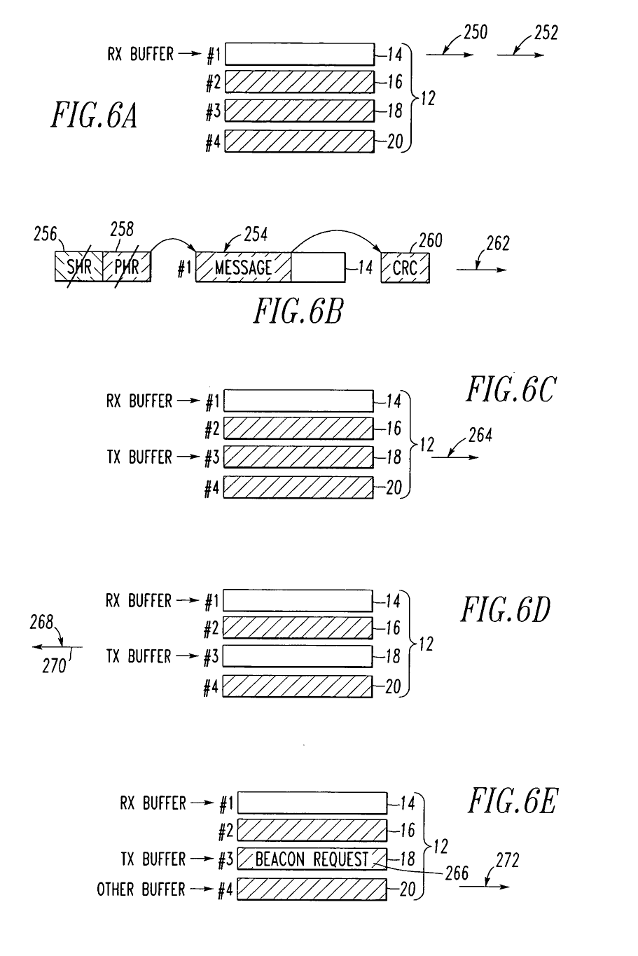

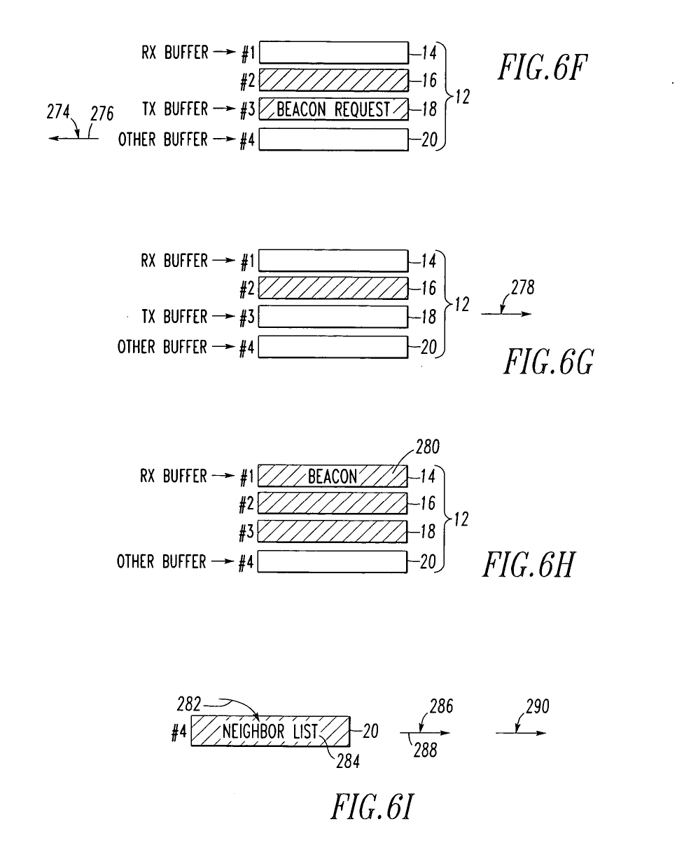

Referring to FIGS. 1 and 6A-6I, an Other Data Request Scenario (e.g., to store a PAN descriptor list while doing an active scan) is shown.

First (FIG. 6A), before a data packet can be received, the MAC layer 8 requests with Buffer Request message 250 a receive buffer (e.g., buffer 14) from the BME 2 and initializes, at message 252, the physical layer 10, in order that data packets can be received.

Next (FIG. 6B), the physical layer 10 receives an incoming data packet 254 and writes it into the current receive buffer 14. The synchronization header (SHR) 256 and PHY header (PHR) 258 are not saved in the buffer 14. After the CRC 260 has been checked, the physical layer 10 issues a PD_DATA.indication primitive 262 to the MAC layer 8 indicating the buffer 14.

Then (FIG. 6C), the MAC layer 8 requests with Buffer Request message 264 a new “TX” buffer from the BME 2, in order to send a (neighbor) discovery request, such as a MAC Beacon request 266 (FIG. 6E). The MAC Beacon Request 266 is an aggregation of several packets (beacons) that the MAC layer 8 has to store somewhere for concatenation. After all the beacons are finished, the MAC layer 8 can send this buffer to the network layer 6. Hence, the buffers 12 of the BME 2 can be employed for temporal storage of data. Normally, however, each of the buffers 12 is employed for one incoming or outgoing data packet or message.

Next (FIG. 6D), the BME 2 checks if a buffer (e.g., buffer 20) is available and if there is at least one transmit buffer (e.g., buffer 18). When the BME 2 grants, at return event 268, the Buffer Request message 264 (FIG. 6C), it returns the buffer number 270 (e.g., #3).

Then (FIG. 6E), the MAC layer 8 requests with Buffer Request message 272 a new “Other” buffer (e.g., buffer 20) from the BME 2, in order to collect the various (neighbor) discovery responses, such as MAC Beacons, extract information therefrom and form the Neighbor List 284 (FIG. 6I).

Next (FIG. 6F), the BME 2 checks if a buffer (e.g., buffer 20) is available and if there is at least one transmit buffer (e.g., buffer 18). When the BME 2 grants, at return event 274, the Buffer Request message 272, it returns the buffer number 276.

Then (FIG. 6G), upon transmission of the Beacon Request 266 (FIG. 6E), the MAC layer 8 sends a Buffer Release message 278 to the BME 2, in order to release the “TX” buffer 18.

Next (FIG. 6H), when a beacon is returned, the MAC layer 8 copies, at 282 (FIG. 6I), the contents 280 from the PHY receive buffer 14, in order to begin to build a neighbor list 284 (which will be sent to the network layer 6 when complete). The MAC layer 8 continues to collect beacon messages 280 until the neighbor list 284 is complete. The MAC layer 8, then, fills the “Other” buffer 20 with the completed list. The MAC layer 8, then, issues a MCPS_DATA.indication primitive 286 to the network layer 6, indicating the buffer number 288 (e.g., #4) and handing control (ownership) of the buffer 20 to the network layer 6. The network layer 6 removes the stored data of the neighbor list 284 from the “Other” buffer 20 that was indicated to it. Upon completion of reading that neighbor list 284, the network layer 6 releases, at BME_ReleaseBuffer event 290, the “Other” buffer 20 back to the BME 2.

### EXAMPLE 13

If conflicts arise (e.g., too many requests from the layers 4,6,8 to the BME 2, but not enough buffers 12 are available), then the BME management mechanism stops since the quantity of buffers 12 is insufficient.

### EXAMPLE 14

As an alternative to Example 13, the BME 2 sends a message to the requesting one of the layers 4,6,8 telling it to wait and try again. Hence, if the BME 2 denies that layer one of the buffers 12, then that layer may re-request a buffer at a later time.

### EXAMPLE 15

The BME 2 may employ a queue (not shown) of requests from the various layers 4,6,8.

The BME 2 can act as a general-purpose memory allocation mechanism. The BME 2 does not employ a copy frame model or a linked list model. Instead, the buffers 12 are shared between all layers 4,6,8,10, thereby optimizing buffer usage. Message frames are never copied from a buffer of one of the layers 4,6,8,10 to the buffer of the next layer, thereby minimizing processing time. Hence, the BME 2 does not require complex management functionality.

Furthermore, the buffers 12 are independent of incoming and outgoing traffic flow. The pre-allocation of space for message headers is added by the lower layers (e.g., 6,8).

Although the exemplary BME 2 is implemented in software, the BME may be implemented in hardware and/or software.

The application layer 4, the network layer 6, the MAC layer 8, and the top part of the physical layer 10 are implemented in software, although these layers may be implemented in hardware and/or software. The bottom part of the physical layer 10 (e.g., the transceiver 84 of FIG. 3) is hardware.

Although the node 80 of FIG. 3 may be part of an ad-hoc, mesh type network, any suitable routing protocol or algorithm (e.g., DSR, Ad hoc on Demand Distance Vector (AODV), or proactive source routing (PSR)) may be employed. In a PSR routing technique, the NC appends a complete list of addresses from that source to the destination ND for downstream communications (from the NC). For multi-hop downstream communications, the receiving and repeating ND removes its address from the list of addresses from that ND to the next or destination ND. For upstream communications (toward the NC), the originating ND appends its address in the original message to an upstream node. For multi-hop upstream communications, the receiving and repeating ND appends its address to the list of addresses from that ND to the next upstream ND or to the NC.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the fill breadth of the claims appended and any and all equivalents thereof.

What is claimed is:

1. A method of managing a plurality of communication buffers, said method comprising:
employing a plurality of communication layers;
employing a buffer manager for said communication buffers, said buffer manager being independent of the communication layers;
requesting by one of the communication layers one of the communication buffers from the buffer manager;
responsive to said requesting, receiving at said one of the communication layers an identification of said one of the communication buffers from the buffer manager;
employing said one of the communication buffers at said one of the communication layers; and
releasing by one of the communication layers said one of the communication buffers to the buffer manager or indicating by one of the communication layers said one of the communication buffers to another one of said communication layers.

2. The method of claim 1 further comprising
responsive to said indicating, requesting by said another one of the communication layers said one of the communication buffers from the buffer manager; and
responsive to said requesting by said another one of the communication layers, returning at least one pointer to said one of the communication buffers from the buffer manager to said another one of the communication layers.

3. The method of claim 2 further comprising
including a buffer number with said identification of said one of the communication buffers from the buffer manager;
including said buffer number with said indicating by one of the communication layers said one of the communication buffers to another one of said communication layers; and
including said buffer number with said requesting by said another one of the communication layers said one of the communication buffers from the buffer manager.

4. The method of claim 2 further comprising
including as said at least one pointer a first pointer to a header field and second pointer to a footer field in said one of the communication buffers.

5. The method of claim 4 further comprising
employing a fixed size of said header field; and
employing a start pointer as said first pointer.

6. The method of claim 5 further comprising
writing by said another one of the communication layers to said header field and said footer field; and
indicating said buffer number by said another one of the communication layers to yet another one of said communication layers.

7. The method of claim 1 further comprising
responsive to said requesting, setting said one of the communication layers as owner of said one of the communication buffers by the buffer manager.

8. The method of claim 2 further comprising
responsive to said requesting by said another one of the communication layers, setting said another one of the communication layers as owner of said one of the communication buffers by the buffer manager.

9. The method of claim 2 further comprising
including as said at least one pointer a pointer to a header field in said one of the communication buffers.

10. The method of claim 9 further comprising
employing an end pointer as said pointer to a header field;
employing a start and an end of said header field; and
writing by one of the communication layers to said header field in reverse order from the end to the start thereof.

11. The method of claim 1 further comprising
releasing by one of the communication layers said one of the communication buffers to the buffer manager; and
requesting by one of the communication layers one of the communication buffers from the buffer manager.

12. The method of claim 1 further comprising
employing as said communication buffers at least a transmit buffer, a receive buffer, a dedicated MAC buffer and another buffer.

13. The method of claim 1 further comprising
employing as one of said communication buffers a transmit buffer;
employing as at least some of said communication layers an application layer, a network layer and a MAC layer; and
requesting said transmit buffer from one of said application layer, said network layer and said MAC layer.

14. The method of claim 1 further comprising
employing as one of said communication buffers a receive buffer;
employing as one of said communication layers a MAC layer; and
requesting said receive buffer from said MAC layer.

15. The method of claim 1 further comprising
employing as some of said communication buffers a receive buffer and a transmit buffer;
employing as at least some of said communication layers an application layer, a network layer and a MAC layer; and
releasing said receive buffer or said transmit buffer from one of said application layer, said network layer and said MAC layer.

16. The method of claim 1 further comprising
employing as some of said communication buffers a receive buffer and a transmit buffer;
employing as at least some of said communication layers an application layer, a network layer and a MAC layer;
employing a length for each of the receive buffer and the transmit buffer; and
requesting a change by the buffer manager of the length of said receive buffer or said transmit buffer from one of said application layer, said network layer and said MAC layer.

17. The method of claim 1 further comprising
employing as some of said communication buffers a receive buffer, a transmit buffer and another buffer;
employing as some of said communication layers a network layer and a MAC layer;
requesting said another buffer from the buffer manager by said MAC layer;
receiving at said MAC layer an identification of said another buffer from the buffer manager;
writing data to said another buffer from said MAC layer;
indicating by said MAC layer said another buffer to said network layer; and
reading said data from said another buffer by said network layer.

18. The method of claim 17 further comprising
releasing by said network layer said another buffer to the buffer manager.

19. The method of claim 13 further comprising
creating a message frame in said transmit buffer by one of said application layer, said network layer and said MAC layer.

20. The method of claim 19 further comprising
transmitting said message frame;
verifying said transmitting; and
releasing by said one of said application layer, said network layer and said MAC layer said transmit buffer to the buffer manager.

21. The method of claim 13 further comprising
granting said requesting said transmit buffer from said application layer, said network layer and said MAC layer by said buffer manager on a first-come-first-served basis.

22. The method of claim 14 further comprising
receiving a message frame in said receive buffer; and
reserving another receive buffer of said communication buffers by said buffer manager responsive to said receiving a message frame.

23. The method of claim 14 further comprising
receiving a message frame in said receive buffer;
responsive to said indicating, requesting by said another one of the communication layers said one of the communication buffers from the buffer manager; and
returning a pointer to said one of the communication buffers from the buffer manager to said another one of the communication layers.

24. The method of claim 23 further comprising
reading data from the message frame in said receive buffer by said another one of said communication layers; and
indicating by said another one of the communication layers said receive buffer to yet another one of said communication layers.

25. The method of claim 24 further comprising
responsive to said indicating by said another one of the communication layers, requesting by said yet another one of the communication layers said receive buffer from the buffer manager; and
returning another pointer to said receive buffer from the buffer manager to said yet another one of the communication layers.

26. The method of claim 24 further comprising
prior to said returning another pointer, adjusting said pointer to said another pointer to point to different data from the message frame in said receive buffer for said yet another one of said communication layers; and
reading said different data from the message frame in said receive buffer by said yet another one of said communication layers.

27. The method of claim 26 further comprising
releasing by said yet another one of said communication layers said receive buffer to the buffer manager.

28. The method of claim 1 further comprising
requesting another one of said communication buffers or a pointer to said one of said communication buffers from the buffer manager by one of said communication layers; and
granting access to said another one of said communication buffers or said pointer, respectively, to said one of said communication layers by said buffer manager.

29. The method of claim 1 further comprising
granting access to one of said communication buffers to one of said communication layers by said buffer manager; and
releasing said access.

30. The method of claim 1 further comprising
employing as one of said communication buffers a receive buffer;
requesting said receive buffer from one of said communication layers;
receiving a message frame in said receive buffer;
removing data of a particular size from the message frame in said receive buffer by said one of said communication layers responsive to said receiving a message frame; and
informing the buffer manager of said particular size by said one of said communication layers.

31. The method of claim 1 further comprising
employing as one of said communication buffers a receive buffer;
requesting said receive buffer from one of said communication layers;
receiving a message frame in said receive buffer;
removing data of a particular size from the message frame in said receive buffer by said one of said communication layers responsive to said receiving a message frame; and
requesting the buffer manager to change said receive buffer to a transmit buffer by said one of said communication layers.

32. The method of claim 31 further comprising
employing a network layer as said one of said communication layers; and
transmitting a message frame from said transmit buffer.

33. The method of claim 1 further comprising
employing one of said communication buffers to temporarily store data from one of said communication layers; and
reading said data from another one of said communication layers.

34. A node comprising:
a processor including a memory, a transceiver and a communication routine,
wherein said memory includes a plurality of communication buffers, and
wherein said communication routine includes a buffer manager adapted to manage said communication buffers and a plurality of communication layers having a physical layer associated with said transceiver, said buffer manager being independent of said communication layers, one of said communication layers being adapted to request one of the communication buffers from the buffer manager, said buffer manager, responsive to said request, being adapted to provide to said one of the communication layers an identification of said one of the communication buffers, said one of the communication layers being adapted to employ said one of the communication buffers, and being adapted to release said one of the communication buffers to the buffer manager or to indicate said one of the communication buffers to another one of said communication layers.

35. The node of claim 34 wherein said node is an LR-WPAN node and said transceiver is a wireless transceiver.

36. The node of claim 34 wherein said node is a network device.

37. The node of claim 34 wherein said node is a network coordinator.
